(19) United States
(12) Patent Application Publication
(10) Pub. No.: US 2007/0165146 A1
(43) Pub. Date: Jul. 19, 2007

(54) LIQUID CRYSTAL DISPLAY

(76) Inventors: Hyeong-Jun Park, Cheonan-si (KR); Chung-Hun Ha, Seoul (KR); Hyang-Shik Kong, Cheonan-si (KR)

Correspondence Address: F. CHAU & ASSOCIATES, LLC, 130 WOODBURY ROAD, WOODBURY, NY, 11797, US

(21) Appl. No.: 11/567,460

(22) Filed: Dec. 6, 2006

(30) Foreign Application Priority Data
Jan. 19, 2006 (KR) 10-2006-0005716

(51) Int. Cl. G02F 1/1343; G02F 1/136

(52) U.S. Cl. 349/38; 349/43

(57) ABSTRACT

A liquid crystal display includes a gate line (formed on an insulating substrate) including a gate electrode, a gate insulation layer formed on the gate line, a semiconductor layer formed on the gate insulation layer., and a data line and a drain electrode formed on the semiconductor layer (stripe). A borderline (side edge) of the semiconductor layer (stripe) is positioned at the outside of a borderline (side edge) of the data line. In this way, by minimizing the overlap of the data line and the pixel electrode (so that a width of the data line is smaller than that of the semiconductor layer (stripe), parasitic capacitance is reduced, so that vertical line blur can be prevented.

### CROSS-REFERENCE TO RELATED APPLICATION

This application claims priority, under 35 U.S.C. §119, of Korean Patent Application No. 1020060005716 filed in the Korean Intellectual Property Office on Jan. 19, 2006, the entire contents of which are incorporated herein by reference.

### BACKGROUND OF THE INVENTION

1. Field of the Invention

The present invention relates to a liquid crystal display.

2. Description of the Related Art

A general liquid crystal display (LCD) includes two display panels provided with pixel electrodes and a common electrode, respectively, and a liquid crystal layer having an anisotropic dielectric properties therebetween. The pixels, each having a pixel electrode are arranged in an array (square matrix) and are connected to switching elements such as thin film transistors (TFT) to receive a data voltage row by row in a sequential manner. The common electrode is formed over an entire surface of the display panel to distribute a common voltage to all the pixels. A pixel electrode, the common electrode, and a liquid crystal layer therebetween constitute a liquid crystal capacitor, and the liquid crystal capacitor and a switching element connected thereto become a basic unit constituting a pixel. Such a liquid crystal display applies a voltage to two electrodes in each pixel to form an electric field in the liquid crystal layer (in each pixel), and adjusts the electric field strength to vary the transmittance of light passing through the liquid crystal layer to obtain a desired image.

Due to parasitic capacitance caused by the overlap of the data lines and the pixel electrode, so-called vertical line blur in which a black stripe is formed along the data line may be generated.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of the present invention provides a liquid crystal display having the advantage of reducing vertical line blur.

An exemplary embodiment of the present invention provides a liquid crystal display including an upper panel and a lower panel, wherein the lower panel includes gate lines (including gate electrodes) formed on an insulating substrate, a gate insulation layer formed on the gate lines, a semiconductor layer formed on the gate insulation layer, and data lines (perpendicular to the gate lines) and drain electrodes formed on the semiconductor layer. A borderline of the semiconductor layer is positioned at the outside of a borderline of the data line.

A part of each gate electrode may be chamfered.

Each data line may include a plurality of source electrodes each extended toward a drain electrode, and each drain electrode may include a first part surrounded with the source electrode and a second part at the outside thereof; and the width of the first part (of the drain electrode) may be about 5 μm and the width of the second part may be about 7 μm.

The liquid crystal display may further include a light source for supplying light to the upper panel and the lower panel, wherein the semiconductor layer may interrupt light from the light source and wherein the semiconductor layer may include an intrinsic semiconductor layer and an doped semiconductor layer.

The lower panel may further include pixel electrodes connected to the drain electrodes, and at least part of each data line is not be overlapped with a pixel electrode.

A distance between two pixel electrodes disposed at either side of a data line may be about 6 μm.

The upper panel may include a light blocking member, and an alignment margin which is a distance between a pixel electrode and a borderline of the light blocking member or the semiconductor layer may be about 3 μm at the left side and about 4 μm at the right side.

The lower panel may further include a first passivation layer formed on the data lines and the drain electrodes, a color filter formed on the first passivation layer, a second passivation layer formed on the color filter, and the pixel electrodes formed on the second passivation layer.

### BRIEF DESCRIPTION OF THE DRAWINGS

The accompanying drawings briefly described below illustrate exemplary embodiments of the present invention, and, together with the description, serve to explain the principles of the present invention.

FIG. 1 is a block diagram of a liquid crystal display according to an exemplary embodiment of the present invention;

FIG. 2 is an equivalent circuit diagram of one pixel of a liquid crystal display according to an exemplary embodiment of the present invention;

FIG, 3 is a layout view of thin film transistor array panel according to an exemplary embodiment of the present invention,

FIG. 4 Is a cross-sectional view of a liquid crystal display including the thin film transistor array panel taken along line IV-IV of FIG. 3;

FIG. 5 is an exploded diagram of a part of the thin film transistor array panel shown in FIG. 3; and

FIG. 6 is a cross-sectional view of a liquid crystal display including the thin film transistor array panel taken along line VI-VI of FIG. 5.

With reference to the accompanying drawings., the present invention will be described in order for those skilled in the art to be able to implement the invention.

To clarify multiple layers and regions, the thicknesses of the layer thicknesses are enlarged (exaggerated) in the drawings. Like reference numerals designate like elements throughout the specification. When it is stated that any part, such as a layer, film, area, or plate is positioned “on”, “upon” or “over” another part, it means that the part is directly on the other part or above the other part with at least one intermediate part. On the other hand, if any part is said to be positioned “directly” on another part, it means that there is no intermediate part between the two parts.

### DETAILED DESCRIPTION OF THE EXEMPLARY EMBODIMENTS

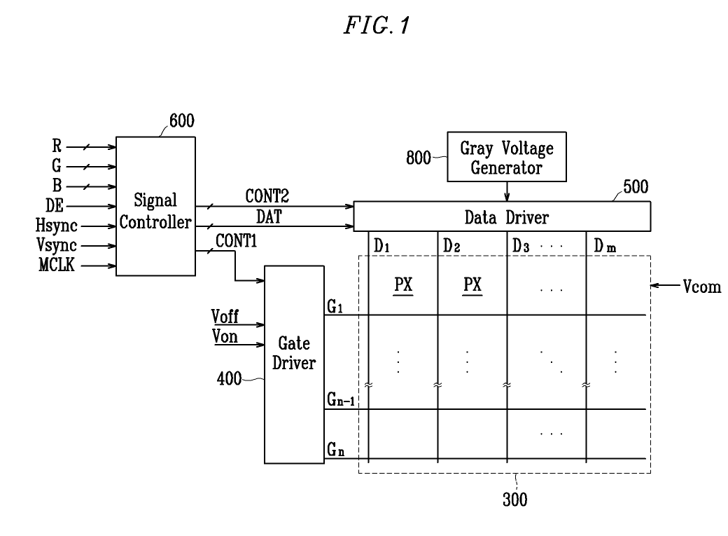

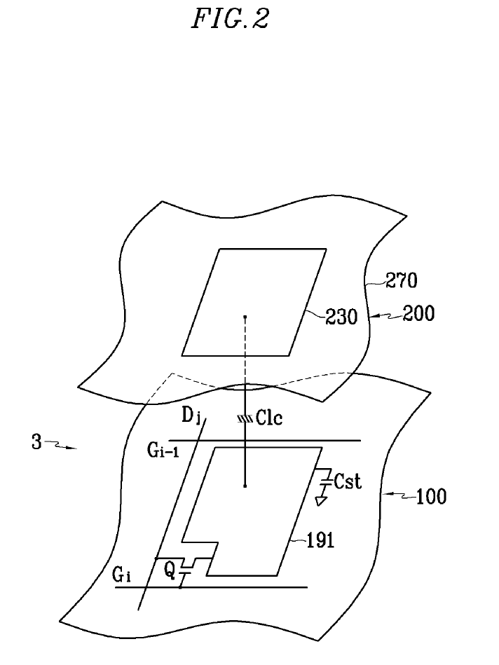

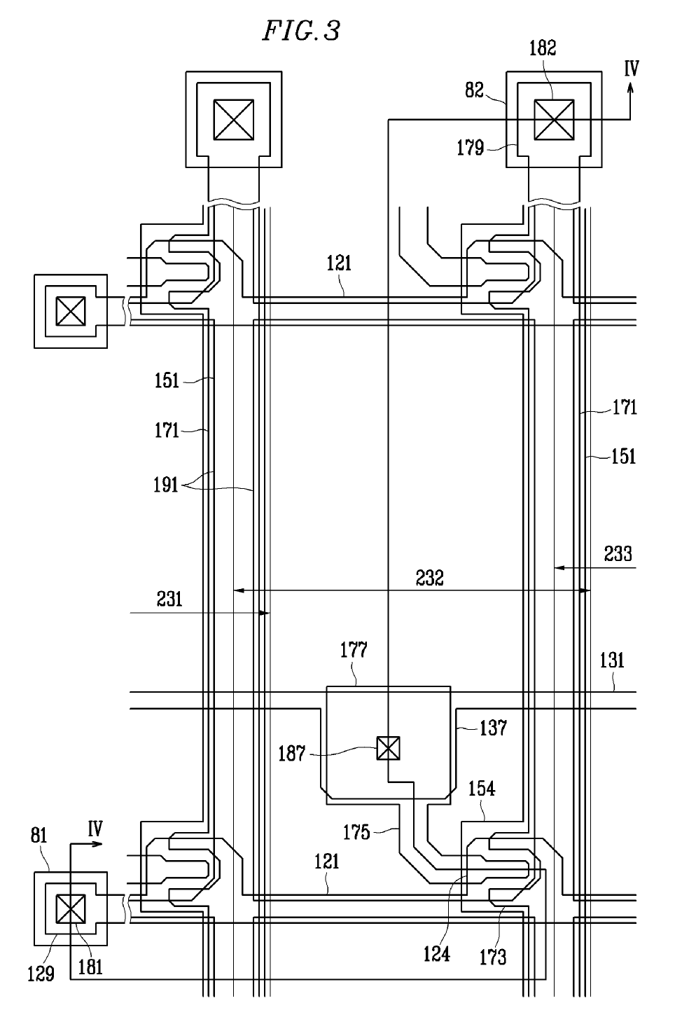

FIG, 1 is a block diagram of a liquid crystal display according to an exemplary embodiment of the present invention, and FIG. 2 is an equivalent circuit diagram of one pixel of the liquid crystal display of FIG. 1.

As shown in FIG. 1, the liquid crystal display according to an exemplary embodiment of the present invention includes a liquid crystal panel assembly 300, a gate driver 400 and a data driver 500 connected to the assembly 300, a gray voltage generator 800 connected to the data driver 500, and a signal controller 600 for controlling them.

The liquid crystal panel assembly 300 includes a plurality of signal lines (G₁ to Gₙ, D₁ to Dₘ) and a plurality of pixels (PX) connected to the signal lines and arranged approximately in a matrix shape from an equivalent circuit view. The liquid crystal panel assembly 300 includes lower and upper panels 100 and 200 facing each other and a liquid crystal layer 3 therebetween as seen in a structural view of FIG. 2.

The signal lines (G₁ to Gₙ, D₁ to Dₘ) include a plurality of gate lines (G₁ to Gₙ) for transferring gate signals (also referred to as “scanning signals”) and a plurality of data lines (D₁ to Dₘ) for transferring data signals. The gate lines (G₁ to Gₙ) are extended approximately in a row (horizontal) direction and parallel with each other, and the data lines (D₁ to Dₘ) are extended approximately in a column (vertical) direction and parallel with each other.

Each pixel (PX): for example a pixel (PX) connected to an i-th (i=1, 2, n) gate line (Gᵢ) and a j-th (j=1, 2, m) data line (Dj), includes a switching element Q connected to signal lines (Gᵢ and Dⱼ), a liquid crystal capacitor (Clc) connected to the element Q, and a storage capacitor (Cst). The storage capacitor (Cst) may be omitted as needed.

The switching element Q is a three-terminal device such as a thin film transistor and is provided in the lower panel 100, and a control terminal thereof is connected to one of the gate lines (Gᵢ), an input terminal thereof is connected to one of the data lines (Dⱼ), and an output terminal thereof is connected to the liquid crystal capacitor (Clc) and the storage capacitor (Cst) of its respective pixel.

The liquid crystal capacitor (Clc) has a pixel electrode 191 at the lower panel 100 and a common electrode 270 at the upper panel 200 as its two terminals, and a liquid crystal layer 3 between the two electrodes 191 and 270 functions as its dielectric material. The pixel electrode 191 is connected to the switching element Q, and the common electrode 270 is formed on an entire surface of the upper panel 200 and receives a common voltage Vcom. Alternatively, unlike as shown in FIG. 2, the common electrode 270 may be provided in the lower panel 100, and at least one of the two electrodes 191 and 270 may be formed in a line shape or a bar shape.

The storage capacitor (Cst) is an assistant of the liquid crystal capacitor (Clc) and is formed of an overlap of a separate signal line (not shown) and the pixel electrode 191 provided in the lower panel 100 across an insulator, and a predetermined voltage such as a common voltage Vcom is applied to the separate signal line. However, the storage capacitor (Cst) may be alternatively formed by an overlap of the pixel electrode 191 and a previous gate line on the electrode 191 via an insulator.

In order to produce color, each pixel (PX) displays one of the primary colors (spatial division) or alternatively displays the primary colors depending on time (temporal division), and a desired color is obtained by the spatial and temporal sum of the primary colors (red, green, and blue). FIG. 2 shows as an example of spatial division in which each pixel (PX) is provided with a color filter 230 for displaying one of the primary colors in a region of the upper panel 200 corresponding to the pixel electrode 191. Alternatively, unlike as shown in FIG. 2, the color filter 230 may be provided on or under the pixel electrode 191 of the lower panel 100.

At least one polarizer (not shown) for polarizing light is attached to the outersurface of the liquid crystal panel assembly 300.

Referring again to FIG, 1, the gray voltage generator 800 generates two sets of gray voltages (or reference gray voltages) related to transmittance of the pixel (PX). One of the two sets of gray voltages has a positive polarity with respect to a common voltage Vcom and the other set has a negative polarity.

The gate driver 400 is connected to the gate lines (G₁ to Gₙ) of the liquid crystal panel assembly 300 to apply a gate signal consisting of a combination of a gate-on voltage Von and a gate-off voltage Voff to the gate lines (G₁ to Gₙ).

The data driver 500 is connected to the data lines (D₁ to Dₘ) of the liquid crystal panel assembly 300, and it selects a gray voltage from the gray voltage generator 800 and applies the voltage as a data signal to the data lines (D₁ to Dₘ). However, when the gray voltage generator 800 does not supply a voltage for all grays but supplies only a predetermined number of reference gray voltages, the data driver 500 divides the reference gray voltage, generates a gray voltage for all grays, and selects a data voltage from among them.

The signal controller 600 controls the gate driver 400, the data driver 500: etc.

Each of these driving devices (400, 500, 600, and 800) may be directly mounted on the liquid crystal panel assembly 300 in a form of at least one IC chip, mounted on a flexible printed circuit film (not shown) to be attached to the liquid crystal panel assembly 300 in a form of a tape carrier package (TCP), or mounted on a separate printed circuit board (PCB) (not shown). Alternatively, these driving devices (400, 5001 600, and 800), the signal lines (G₁ to Gₙ, D₁ to Dₘ), and the thin film transistor switching element Q, etc. may be integrated with the liquid crystal panel assembly 300. Furthermore, the driving devices (400, 500, 600, and 800) may be integrated in a single chip, and at least one of these devices or at least one circuit element of these devices may be disposed outside of the single chip.

Now, an operation of the liquid crystal display of FIG. 1 will be described in detail.

The signal controller 600 receives input image signals R, G, and B and an input control signal for controlling the display of the signals from an external graphics controller (not shown). The input control signal includes, for example, a vertical synchronization signal Vsync, a horizontal synchronizing signal Hsync, a main clock signal MCLK, and a data enable signal DE,

The signal controller 600 appropriately processes input image signals R, G, and B to correspond to an operating condition of the liquid crystal panel assembly 300 based on input image signals P, G, and B and input control signals, generates a gate control signal CONT1 and a data control signal CONT2, then transfers the gate control signal CONT1 to the gate driver 400 and transfers the data control signal CONT2 and the processed image signal DAT to the data driver 500.

The gate control signal CONT1 includes a scanning start signal (STV) for instructing to start scanning and at least one clock signal for controlling an output period of a gate-on voltage Von. The gate control signal CONT1 may further include an output enable signal (OE) for limiting a sustain time of the gate-on voltage Von.

The data control signal CONT2 includes a horizontal synchronization start signal (STH) for informing of start of transfer of image data to one row (set) of pixels (PX) and a load signal (LOAD) and a data clock signal (HCLK) for applying a data signal to data lines (D₁ to Dₘ). The data control signal CONT2 may further include an inversion control signal (RVS) for reversing the polarity of the data voltages (with respect to the common voltage Vcom).,

The data driver 500 receives a digital image signal DAT for one row of pixels (PX) depending on the data control signal CONT2 from the signal controller 600, converts the digital image signal DAT to an analog data voltages by selecting a gray voltage corresponding to each pixel's digital image signal DAT, and then applies the converted signal to corresponding data lines (D₁ to Dₘ).

The gate driver 400 applies a gate-on voltage Von to gate lines (G₁ to Gₙ) depending on the gate control signal CONT1 from the signal controller 600 to turn on a switching element Q connected to the gate lines (G₁ to Gₙ). Then, a data voltage applied to the data lines (D₁ to Dₘ) is applied to the corresponding pixels (PX) through the switching elements Q that are turned ON.

The difference between of the data voltage applied to the pixel (PX) and the common voltage Vcom is expressed as a charge voltage, i.e., a pixel voltage of the liquid crystal capacitor (Clc). Liquid crystal molecules change their arrangement depending on a magnitude of a pixel voltage, so that polarization of light passing through the liquid crystal layer 3 is changed. The change of polarization results in the transmittance of light by the polarizer attached to the display panel assembly 300.

By repeating the process with a unit of one horizontal period (referred to as “1H”, which is the same as one period of a horizontal synchronization signal Hsync and a data enable signal DE), a gate-on voltage Von is sequentially applied to all gate lines (G₁ to Gₙ), whereby a data voltage is applied to all pixels (PX), so that an image of one frame is displayed.

A state of an inversion signal (RVS) applied to the data driver 500 is controlled so that a next frame starts when one frame ends and the polarity of a data signal applied to each pixel (PX) is opposite to the polarity during a previous frame (“frame inversion”). According to characteristics of the inversion control signal (RVS) even within one frame, the polarity of a data voltage flowing through one data line may be changed (e.g., row inversion and dot inversion), or the polarity of the data voltage applied to one pixel row may be different from each other (e.g., column inversion, dot inversion).

Now, the structure of a thin film transistor (TFT) array panel (at 300 in FIG. 1) for the liquid crystal display of FIG. 1 will be described with reference to FIGS. 3 to 6.

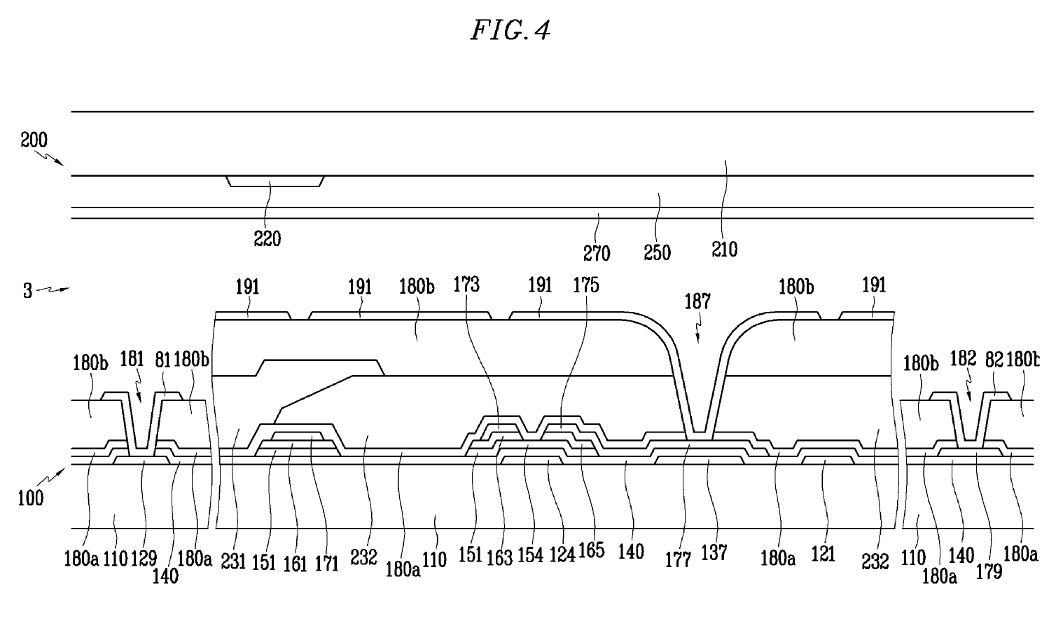

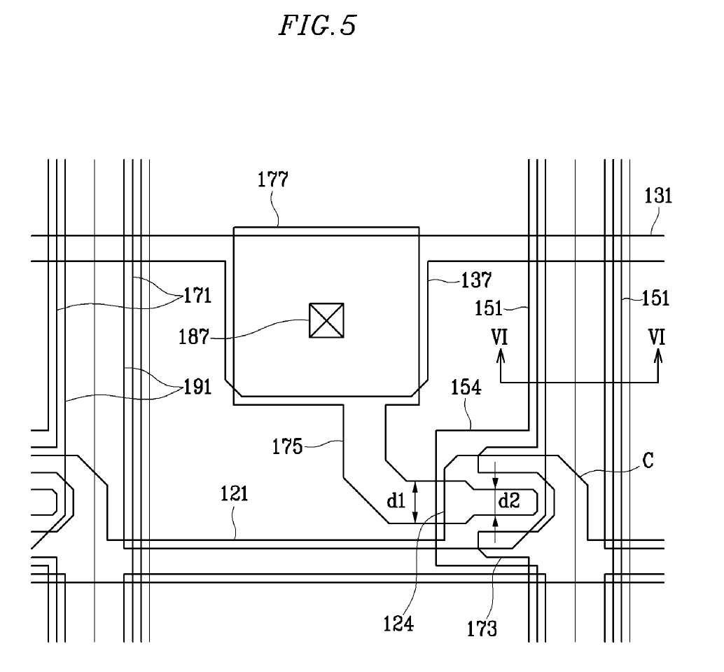

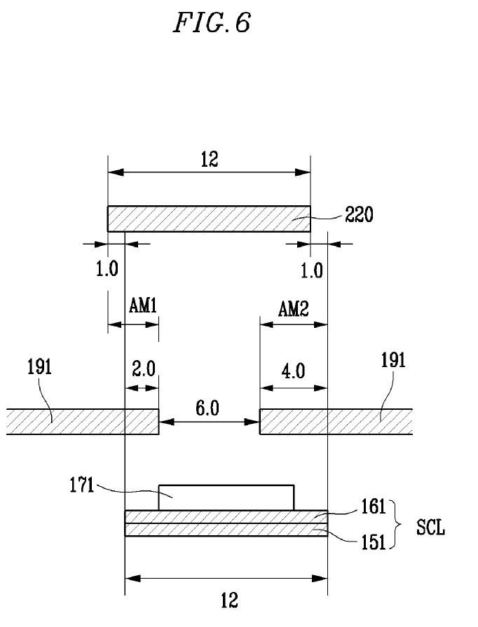

FIG. 3 is a layout view of thin film transistor (TFT) array panel according to an exemplary embodiment of the present invention, and FIG. 4 is a cross-sectional view of a liquid crystal display including the thin film transistor array panel taken along section line IV-IV of FIG. 3. FIG. 5 is an exploded diagram of a part of the thin film transistor array panel shown in FIG, 3 and FIG. 6 is a cross-sectional view of a liquid crystal display taken along section line VI-VI of FIG. 5.

The liquid crystal display according to an exemplary embodiment of the present invention includes a thin film transistor array panel 100, a common electrode panel 200 facing the panel 100, and a liquid crystal layer 3 interposed therebetween.

First, the structure of the common electrode panel 200, which is the upper panel, will be described.

On the upper insulating substrate 210 facing the lower insulating substrate 110, an opening is formed at a part corresponding to a pixel surrounded with a gate line 121 and a data line 171, and a light blocking member 220 called a black matrix (which is made of an organic material including black pigment to intercept leaking light between neighboring pixels).

An overcoat 250, which is made of an insulating material, is provided on the insulating substrate 210 on which the light blocking member 220 is provided.

On the overcoat 250, an electrical field for driving liquid crystal molecules is established by the common electrode 270 (and the pixel electrode 191), which is made of a transparent conductive material such as ITO or IZO.

On the two panels 100 and 200, an alignment layer (not shown) for aligning liquid crystal molecules of the liquid crystal material layer 3 is provided, and polarizers (not shown) are attached to the outside surface of the two panels 100 and 200.

Next, the structure of the thin film transistor array panel 100, which is the lower panel, will be described in further detail.

A plurality of gate lines 121 and a plurality of storage electrode lines 131 are provided on the insulating substrate 110. The gate lines 121 and the storage electrode lines 131 are separated from each other and mainly extend in the horizontal direction.

Each gate line 121 includes a plurality of gate electrodes 124 (protruding upwardly) and a terminal extension 129 having a large area for connection with another layer or an external device. A part (C) of the gate electrode 124 is chamfered (see FIG. 5).

Each storage electrode line 131 receives a predetermined voltage such as a common voltage and includes a plurality of extensions 137 (protruding downwardly),

The gate lines 121 and the storage electrode lines 131 may be made of an aluminum compound such as aluminum (Al) or an aluminum alloy, a silver compound such as silver (Ag) or a silver alloy, a copper compound such as copper (Cu) or a copper alloy, a molybdenum compound such as molybdenum (Mo) or a molybdenum alloy, chromium (Cr), titanium (Ti), or tantalum (Ta), etc. The gate lines 121 and the storage electrode lines 131 may have a multi-layered structure including two different layers having different physical properties. One of these layers may be made of a metal with low resistivity such as aluminum to reduce signal delay or voltage drop of the gate line 121 and the storage electrode line 131. The other layer may be made of a material such as chromium, molybdenum, a molybdenum alloy (e.g., a molybdenum-tungsten (MoW) alloy), tantalum, and titanium having excellent physical, chemical, and electrical contact characteristics with other materials, specifically IZO (indium zinc oxide) or ITO (indium tin oxide). A combination of a lower layer and an upper layer includes, for example, a chromium lower layer and an aluminum (alloy) upper layer, and an aluminum (alloy) lower layer and a molybdenum upper layer.

A side surface of the gate lines 121 and the storage electrode lines 131 is inclined relative to a surface of the substrate 110 with an inclination angle of about 30 to 80°.

A gate insulation layer 140, which is made of silicon nitride (SiNx) etc., is provided on (e.g., directly on) the gate lines 121.

A plurality of semiconductor stripes 151, which are made of hydrogenated amorphous silicon (referred to as “a-Si”), etc., is provided on the gate insulation layer 140. The semiconductor stripes 151 mainly extend in a vertical direction and include a plurality of projections 154 that are extend the semiconductor material over the gate electrodes 124. In alternative embodiments, semiconductor islands may be formed over the gate electrodes 124.

A plurality of stripe and island ohmic contacts 161 and 165, which are made of a material such as n+ hydrogenated amorphous silicon in which silicide or an n-type impurity is doped with a high concentration, are provided on the semiconductor 151. The ohmic contact stripes 161 are provided with a plurality of protrusions 163, and a pair of a protrusion 163 and an ohmic contact island 165 is positioned on each protrusion 154 of the semiconductor 151.

Side surfaces of the semiconductor 151 and the ohmic contacts 161 and 165 are also inclined relative to a surface of the substrate 110 with an inclination angle of about 30 to 80°.

A plurality of data lines 171 and a plurality of drain electrodes 175 are provided on the ohmic contacts 161 and 165.

Each data line 171 is mainly extended in a vertical direction, (perpendicular to a gate line 121), and transfers a data voltage to one column of pixels PX. Each data line 171 has a terminal extension 179 having a large area to connect to another layer or an external device.

A plurality of branches of each data line 171 (extending toward the drain electrode 175) forms a source electrode 173. Each of the drain electrodes 175 is positioned on a gate electrode 124 and includes one first part surrounded by the source electrode 173 and another part being an extended end part 177 that has a large area overlapping the extension 137 of the storage electrode line 131. A width (d2) of the first part of the drain electrode 175 surrounded by the source electrode 173 is slightly smaller (narrower) than a width (d1) of the other part of the drain electrode 175(not surrounded by the source electrode 173). I It is preferable that the width (d1) is about 7 μm and that the width (d2) is about 5 μm. In this way, the first part of the drain electrode 175 having a small width (d2) and the chamfered gate electrode 124 perform a function of reducing parasitic capacitance between the gate and the drain.

The gate electrode 124, the source electrode 173, the drain electrode 175, and the protrusion 154 of the semiconductor stripe 151 constitute a thin film transistor (TFT), and the channel of the thin film transistor is formed in the protrusion 154 (between the source electrode 173 and the drain electrode 175).

The data line 171 and the drain electrode 175 may be made of a refractory metal such as chromium, a molybdenum alloy, titanium, and tantalum. However, they may also include a low resistance layer and a contact layer.

In the data line 171 and the drain electrode 175, the side surfaces thereof are inclined relative to the surface of the substrate 110 with an angle of about 30 to 80°, similar to the gate line 121.

The ohmic contacts 161 and 165 exist between the semiconductor 151 and the data line 171 (173) and the drain electrodes 175, and perform a function of reducing contact resistance. Furthermore, the semiconductor stripe 151 has a larger width than the data line 171.

A lower passivation layer 180a is provided on the data line 171, the drain electrode 175, and the exposed part of the semiconductor 151.

Stripe-shaped color filters (231 to 233) are provided on the lower passivation layer 180a, Each of the color filters (231 to 233) has one of three primary colors (red, green, or blue). Each of color filters (231 to 233) is positioned between two neighboring data lines 171. Neighboring color filters (231 to 233) are overlapped on the data line 171 to assist prevention of light leakage between adjacent pixels PX. The color filters (231 to 233) do not exist in a peripheral area at which the end part 129 of the gate line 121 and the end part 179 of the data line 171 exist. The color filters (231 to 233) have a plurality of openings positioned on the drain electrode 175 and the openings and the lower passivation layer 180a expose a pad of the drain electrode 175. The edge portion of the filters (231 to 233) have a thickness that is smaller than at other portions to prevent erroneous arrangement of liquid crystal by inducing a step coverage characteristic of the upper layer and for planarizing the display panel, and the overlapped part thereof completely covers the data line 171. However, the edges of the neighboring color filters (231 to 233) may be accurately matched.

An upper passivation layer 180b, which is made of an organic material having an excellent planarization characteristic and photosensitivity, a low dielectric constant insulating material such as a-Si:C:O and a-Si:O:F formed with plasma enhanced chemical vapor deposition (PECVD), or silicon nitride which is an inorganic material, etc. are formed on the color filters (231 to 233).

In the upper and lower passivation layers 180b and 180a, a plurality of contact holes 187 exposing extensions 177 of the drain electrode 175 are formed, and a plurality of contact holes 181 exposing the gate insulation layer 140 and the end part 129 of the gate line 121, and a plurality of contact holes 182 exposing the extension 179 of the data line 171 are formed. The contact holes 181, 182, and 187 have inclined side surfaces, and the contact hole 187 is positioned within the opening of the color filters (231 to 233). Therefore, in the contact holes 181, 182, and 187, a boundary of the lower passivation layer 180a coincides with that of the upper passivation layer 180b. However, the contact hole 187 may expose the upper surface of the color filters (231 to 233) to have a step profile.

A plurality of pixel electrodes 191 and a plurality of contact assistants 81 and 82, which are made of IZO or ITO, are provided on the passivation layers 180a and 180b (e.g., directly on passivation layer 180b).

The pixel electrode 191 is physically and electrically connected to the drain electrode 175 through the contact hole 187 to receive a data voltage from the drain electrode 175.

When the pixel electrode 191 receives an applied data voltage and the common electrode 270 of the display panel 200 receives a common voltage generate, generating an electric field, liquid crystal molecules of the liquid crystal layer 300 between two display panels 100 and 200 are rearranged.

The pixel electrodes 191 overlap neighboring gate lines 121 and data lines 171 to increase an aperture ratio.

In FIG. 6, an overlapping relationship between the pixel electrode 191, the data line 171 under the electrode 191, and a semiconductor layer (SCL) including the semiconductor 151 and the ohmic contact 161 is shown. The units of linear dimensions indicated by numerals bounded by arrows (e.g.: 1.0, 2.0, 4.0, 6.0, 12) in FIG. 6 is ‘μm’.

As described above, a line width of the semiconductor 151 i.e., a line width of the semiconductor layer (SCL), is larger than that of the data line 171. In the figure, as a line width of the semiconductor layer (SCL) is about 12 μm and a line width of the data line 171 is about 8 μm, a line width of the semiconductor layer (SCL) is larger than that of the data line 171 by about 4 μm. The pixel electrode 191 does not overlap the data line 171 at the left side, but overlaps the data line 171 by about 2 μm at the right side. Therefore, a distance between two adjacent pixel electrodes 191 disposed about the data line 171 is 6 μm. This relationship performs reduces parasitic capacitance generated between the pixel electrode 191 and the data line 171 by not overlapping at least one side, (compared to an conventional overlapping structure). Therefore, vertical line defects caused by parasitic capacitance between the pixel electrode 191 and the data line 171 can be reduced.

The semiconductor layer (SCL) performs a function of interrupting light from a light source (not shown) attached at the rear side of the liquid crystal display. In an conventional structure, because a line width of the data line 171 is equal to or larger than that of the semiconductor layer (SCL), the semiconductor layer (SCL) is not exposed. However, in a structure according to the present invention, because a line width of the data line 171 is smaller than that of the semiconductor layer (SCL), the semiconductor layer (SCL) is exposed, so that interference and light from the light source may be generated. The interference may generate a waterfall effect in which an image flows from top to bottom with a stripe shape, and is related to a voltage of an inverter (not shown) controlling the light source and a driving frequency of the liquid crystal display. Therefore, when such a structure is used, the waterfall effect should be inspected for various inverter voltages and driving frequencies and the results are shown in Table 1.

TABLE 1

| | Inverter Voltage | | |
|---|---|---|---|
| Driving Frequency | 7 V | 12 V | 22 V |
| 50 Hz | No/No | No/No | No/No |
| 60 Hz | No/No | No/No | No/No |
| 75 Hz | No/No | No/No | No/No |

Table 1 shows results of a comparison of an conventional structure and a structure according to the present invention regarding whether a waterfall effect is generated when an inverter voltage is 7V, 12V, and 22V, and when a driving frequency is 50 Hz, 60 Hz, and 75 Hz, and it is confirmed that the waterfall effect is not generated in the structure according to the present invention, similar to the conventional structure.

A distance between the pixel electrode 191 and the borderline of the semiconductor layer (SCL) or the light blocking member 220 of the upper panel 200 is an alignment margin. A left alignment margin (AM1) is about 3 μm as a distance between the left edge of the light blocking member 220 and the right edge of the left pixel electrode 191 positioned under the edge. A right alignment margin (AM2) is 4 μm as a distance between the left edge of the right pixel electrode 191 and the right edge of the semiconductor layer (SCL).

The contact assistants 81 and 82 are connected to the extension 129 of the gate line and the end part 179 of the data line, respectively, through the contact holes 181 and 182. The contact assistants 81 and 82 supplement adhesion between the extensions 129 and 179 of the gate line 121 and the data line 171 and an external device and perform a function of protecting them.

As a material of the pixel electrode 191, ITO or a transparent conductive polymer may be used, and an opaque reflective metal may be used in a reflective liquid crystal display. The contact assistants 81 and 82 may be specifically made of IZO or ITO among materials that are different from those of the pixel electrode 191.

In an exemplary embodiment according to the present invention, a structure using five masks is described, but a structure using three or four masks may alternatively be used.

In this way, by minimizing the overlap of the pixel electrode 191 and the data line 171, parasitic capacitance therebetween can be reduced, and by chamfering a part of the gate electrode 124 and reducing a size of the drain electrode 175, parasitic capacitance can be further reduced, so that vertical line defects can be further reduced. Furthermore, as a width of the data line 171 is reduced, an aperture ratio can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising an upper panel and a lower panel, the lower panel comprising:
a gate line including a gate electrode formed on an insulating substrate;
a gate insulation layer formed on the gate line;
a semiconductor stripe formed on the gate insulation layer; and
a data line formed on the semiconductor stripe,
wherein the width of the semiconductor stripe is greater than the width of the data line.

2. The liquid crystal display of claim 1, wherein a part of the gate electrode is chamfered.

3. The liquid crystal display of claim 2, wherein the data line includes a source electrode extended toward the drain electrode, and
the drain electrode includes a first part surrounded by the source electrode and a second part at the outside the source electrode.

4. The liquid crystal display of claim 3, wherein a width of the first part is narrower than the second part.

5. The liquid crystal display of claim 1, the width of the first part is about 5 μm and the width of the second part is about 7 μm.

6. The liquid crystal display of claim 1, further comprising a light source for supplying light through the upper panel and the lower panel,
wherein the semiconductor stripe interrupts light from the light source.

7. The liquid crystal display of claim 5, wherein the semiconductor stripe is part of a semiconductor layer that includes an intrinsic semiconductor layer and a doped semiconductor layer.

8. The liquid crystal display of claim 1 wherein the lower panel further comprises a pixel electrode connected to the drain electrode, and
at least part of the data line is not overlapped with the pixel electrode.

9. The liquid crystal display of claim 7, wherein the distance between nearest perimeter lines of two horizontally adjacent pixel electrodes is about 6 μm.

10. The liquid crystal display of claim 8, wherein the upper panel comprises a light blocking member, and
wherein a first alignment margin, being the distance between a first side edge of the pixel electrode and a borderline of the light blocking memberor the semiconductor stripe, is about 3 μm at the left side

11. The liquid crystal display of claim 8, wherein a second alignment margin, being the distance between a second side edge of the pixel electrode and the semiconductor stripe, is about 4 μm at the right side.

12. The liquid crystal display of claim 8, wherein the lower panel further comprises:
a first passivation layer formed on the data line and the drain electrode,
a color filter formed on the first passivation layer; and
the pixel electrode formed on the color filter.

13. The liquid crystal display of claim 12, further comprising:
a second passivation layer formed on the color filter; and
the pixel electrode is formed on the second passivation layer.

14. A liquid crystal display comprising an upper panel and a lower panel, the lower panel comprising:
a gate line including a chamfered gate electrode formed on an insulating substrate;
a gate insulation layer formed on the gate line;
a semiconductor layer formed on the gate insulation layer; and
a data line, including a source electrode formed on the semiconductor layer;
a drain electrode formed on the semiconductor layer, including a first portion of the drain electrode surrounded by the source electrode and having a width (d2), and including a second portion of the drain electrode not surrounded by the source electrode and having a width (d1), wherein (d1) is greater than width (d2),

15. The liquid crystal display of claim 8, wherein the width (d1) is about 7 μm and the width (d2) is about 5 μm.

16. The liquid crystal display of claim 8, wherein the first portion of the drain electrode is positioned on the gate electrode.

17. The liquid crystal display of claim 8, further comprising,
a storage electrode line;
wherein the drain electrode has a large area overlapping an extension of the storage electrode line.

18. A liquid crystal display, comprising an upper panel and a lower panel, the lower panel comprising:
a gate line including a gate electrode formed on an insulating substrate;
a gate insulation layer formed on the gate line;
a semiconductor layer formed on the gate insulation layer;
a data line formed on the semiconductor layer;
a drain electrode formed on the semiconductor layer;
a first passivation layer formed on the data line and on the drain electrode;
a color filter formed on the first passivation layer;
a pixel electrode formed on the color filter.

19. The liquid crystal display of claim 8, further comprising
a second passivation layer formed on the color filter; and
the pixel electrode is formed on the second passivation layer.
